(19) United States
(12) Patent Application Publication
(10) Pub. No.: US 2026/0092538 A1
(43) Pub. Date: Apr. 2, 2026

(54) SCAVENGE PUMP ASSEMBLY FOR AN AIRCRAFT ENGINE OIL SYSTEM

(71) Applicant: Pratt & Whitney Canada Corp., Longueuil (CA)

(72) Inventors: Simon Baker-Ostiguy, Montreal (CA); Michel Labbe, Montreal (CA); Stephane Gignac, Boucherville (CA)

(21) Appl. No.: 18/900,087

(22) Filed: Sep. 27, 2024

(51) Int. Cl. F01D 25/20

(52) U.S. Cl. CPC F01D 25/20; F05D 2220/323; F05D 2260/98

(57) ABSTRACT

An engine oil system includes an oil tank and a scavenge pump assembly. The scavenge pump assembly includes a drive shaft, a plurality of scavenge pumps, and a scavenge return manifold. Each of the plurality of scavenge pumps includes a pump rotor coupled with the drive shaft. The scavenge return manifold includes a manifold body forming a common outlet passage and a plurality of inlet passages of the scavenge return manifold. The common outlet passage includes a manifold outlet of the scavenge return manifold connected in fluid communication with the oil tank. Each of the plurality of inlet passages includes a manifold inlet of the scavenge return manifold connected in fluid communication with a respective one of the plurality of scavenge pumps. Each of the plurality of inlet passages extends in an oblique direction from the manifold inlet to the common outlet passage.

### TECHNICAL FIELD

This disclosure relates to engine oil systems for aircraft engines.

### BACKGROUND OF THE ART

Engines for aircraft may typically include rotational equipment configured for facilitating aircraft propulsion, generating electrical power, and/or other functions of aircraft operation. In many cases, rotational equipment may require lubrication and/or cooling, for example, using one or more oil systems to distribute oil to the rotational equipment and/or other oil loads. Various engine oil systems are known in the art. While these known systems may be useful for their intended purposes, there is always room in the art for improvement.

### SUMMARY

It should be understood that any or all of the features or embodiments described herein can be used or combined in any combination with each and every other feature or embodiment described herein unless expressly noted otherwise.

According to an aspect of the present disclosure, an engine oil system for an aircraft engine includes an oil tank and a scavenge pump assembly. The scavenge pump assembly includes a drive shaft, a plurality of scavenge pumps, and a scavenge return manifold. Each of the plurality of scavenge pumps includes a pump rotor coupled with the drive shaft. The scavenge return manifold includes a manifold body forming a common outlet passage and a plurality of inlet passages of the scavenge return manifold. The common outlet passage includes a manifold outlet of the scavenge return manifold connected in fluid communication with the oil tank. Each of the plurality of inlet passages includes a manifold inlet of the scavenge return manifold connected in fluid communication with a respective one of the plurality of scavenge pumps. Each of the plurality of inlet passages extends in an oblique direction from the manifold inlet to the common outlet passage.

In any of the aspects or embodiments described above and herein, the common outlet passage may extend along an outlet axis between and to an upstream end and a downstream end, the downstream end may be at the manifold outlet, and the plurality of inlet passages may be arranged axially sequentially along the common outlet passage.

In any of the aspects or embodiments described above and herein, each of the plurality of inlet passages may be disposed on a plane on which the outlet axis lies.

In any of the aspects or embodiments described above and herein, the oblique direction may be substantially the same for each of the plurality of inlet passages.

In any of the aspects or embodiments described above and herein, the scavenge pump assembly may further include a pump housing, the pump housing may form a plurality of pump cavities for the plurality of scavenge pumps, and each of the plurality of inlet passages may be connected in fluid communication with a respective one of the plurality of pump cavities.

In any of the aspects or embodiments described above and herein, the engine oil system may further include a plurality of engine oil loads, and the plurality of scavenge pumps may be connected in fluid communication with the plurality of engine oil loads to pump oil from the plurality of engine oil loads into the scavenge return manifold.

According to another aspect of the present disclosure, an engine for an aircraft propulsion system includes an engine oil system. The engine oil system includes a plurality of engine oil loads, an oil tank, and a scavenge pump assembly forming an oil flow path through the engine oil system. The scavenge pump assembly includes a drive shaft, a plurality of scavenge pumps, and a scavenge return manifold. Each of the plurality of scavenge pumps is operably connected to the drive shaft and configured to pump oil along the oil flow path from the plurality of engine oil loads to the scavenge return manifold. The scavenge return manifold includes a manifold body forming a common outlet passage and a plurality of inlet passages of the scavenge return manifold. The common outlet passage includes a manifold outlet of the scavenge return manifold connected in fluid communication with the oil tank. Each of the plurality of inlet passages includes a manifold inlet of the scavenge return manifold connected in fluid communication with a respective one of the plurality of scavenge pumps. Each of the plurality of inlet passages extends non-orthogonally relative to the common outlet passage.

In any of the aspects or embodiments described above and herein, the engine may further include an engine output shaft operably coupled to the drive shaft to drive rotation of the drive shaft.

In any of the aspects or embodiments described above and herein, the common outlet passage may extend along an outlet axis between and to an upstream end and a downstream end, the downstream end may be at the manifold outlet, and the plurality of inlet passages may be arranged axially sequentially along the common outlet passage.

In any of the aspects or embodiments described above and herein, each of the plurality of inlet passages may be disposed on a plane on which the outlet axis lies.

In any of the aspects or embodiments described above and herein, each of the plurality of inlet passages may extend along an inlet axis from the manifold inlet to the common outlet passage, and the inlet axis may be non-orthogonal relative to an axial direction of the common outlet passage relative to the outlet axis.

In any of the aspects or embodiments described above and herein, each of the plurality of inlet passages may extend in an oblique direction from the manifold inlet to the common outlet passage.

In any of the aspects or embodiments described above and herein, the oblique direction may be substantially the same for each of the plurality of inlet passages.

In any of the aspects or embodiments described above and herein, the scavenge pump assembly may further include a pump housing, the pump housing may form a plurality of pump cavities for the plurality of scavenge pumps, and each of the plurality of inlet passages may be connected in fluid communication with a respective one of the plurality of pump cavities.

According to another aspect of the present disclosure, a method for scavenging oil with an engine oil system of an aircraft engine includes supplying oil to a plurality of engine oil loads of the aircraft engine, scavenging the oil from the plurality of engine loads with a plurality of scavenge pumps by pumping the oil into a scavenge return manifold, with each of the plurality of scavenge pumps, at an oblique direction relative to a common outlet passage of the scavenge return manifold, and directing the oil from each of the plurality of scavenge pumps to an oil tank through the common outlet passage.

In any of the aspects or embodiments described above and herein, the method may further include driving each of the plurality of scavenge pumps with a drive shaft operably connected to a pump rotor of each of the plurality of scavenge pumps.

In any of the aspects or embodiments described above and herein, pumping the oil into the scavenge return manifold with each of the plurality of scavenge pumps may include pumping the oil through a plurality of inlet passages. Each of the plurality of inlet passages may be connected in fluid communication between a respective one of the plurality of scavenge pumps and the common outlet passage.

In any of the aspects or embodiments described above and herein, the common outlet passage may extend along an outlet axis between and to an upstream end and a downstream end, and the plurality of inlet passages may be arranged axially sequentially along the common outlet passage.

In any of the aspects or embodiments described above and herein, the oblique direction may be substantially the same for each of the plurality of inlet passages.

In any of the aspects or embodiments described above and herein, each of the plurality of inlet passages may be disposed on a plane on which the outlet axis lies.

The present disclosure, and all its aspects, embodiments and advantages associated therewith will become more readily apparent in view of the detailed description provided below, including the accompanying drawings.

### DESCRIPTION OF THE DRAWINGS

FIG. 1 illustrates a perspective view of an aircraft including a propulsion system, in accordance with one or more embodiments of the present disclosure.

FIG. 2 schematically illustrates a cutaway, side view of an aircraft propulsion system including a gas turbine engine, in accordance with one or more embodiments of the present disclosure.

FIG. 3 schematically illustrates an engine oil system for an aircraft propulsion system, in accordance with one or more embodiments of the present disclosure.

FIG. 4 schematically illustrates a portion of the engine oil system including a scavenge return manifold, in accordance with one or more embodiments of the present disclosure.

### DETAILED DESCRIPTION

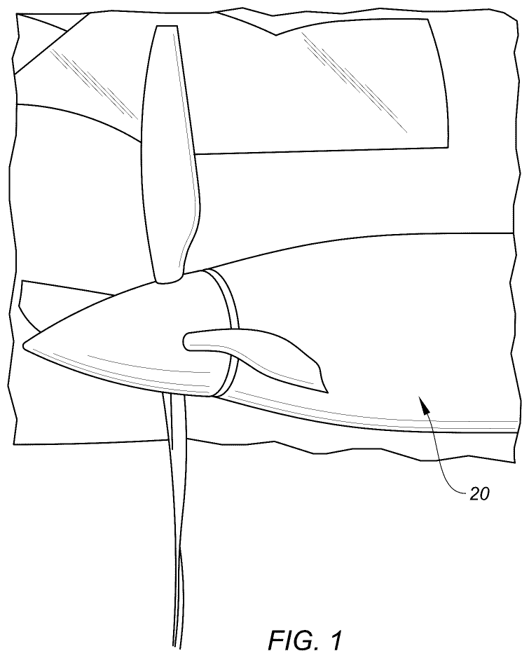

FIG. 1 illustrates a propulsion system 20 for an aircraft. Briefly, the aircraft may be a fixed-wing aircraft (e.g., an airplane), a rotary-wing aircraft (e.g., a helicopter), a tilt-rotor aircraft, a tilt-wing aircraft, or another aerial vehicle. Moreover, the aircraft may be a manned aerial vehicle or an unmanned aerial vehicle (UAV, e.g., a drone).

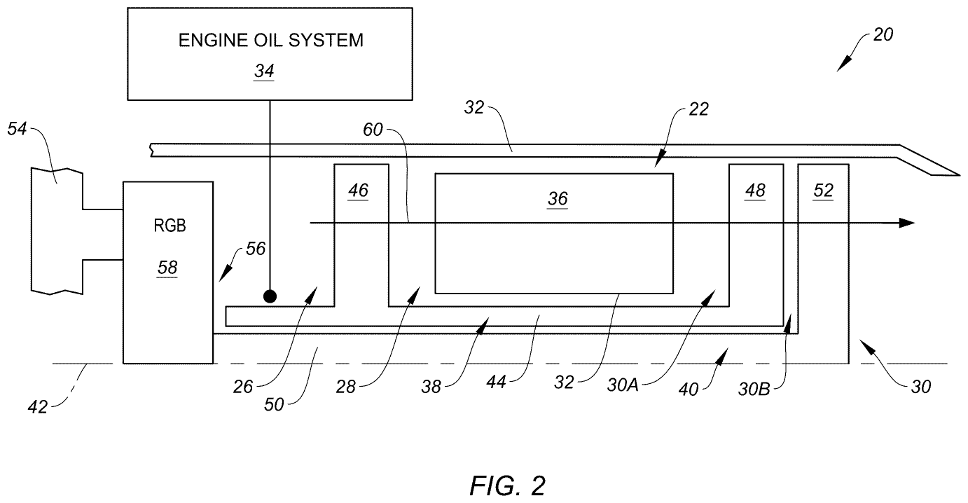

FIG. 2 schematically illustrates a cutaway, side view of the propulsion system 20. The propulsion system 20 of FIG. 2 includes a gas turbine engine 22. The gas turbine engine 22 of FIG. 2 is configured as a turboprop gas turbine engine. However, while the following description and accompanying drawings may refer to the turboprop gas turbine engine 22 of FIG. 2 as an example, it should be understood that aspects of the present disclosure may be equally applicable to other types of gas turbine engines including, but not limited to, a turboshaft gas turbine engine, a turbofan gas turbine engine, a turbojet gas turbine engine, a propfan gas turbine engine, or an open rotor gas turbine engine. Aspects of the present disclosure may be equally applicable to aircraft propulsion systems including other engine configurations such as, but not limited to, rotary engines, piston engines, and the like, or to electric aircraft propulsion systems (e.g., battery-electric propulsion systems, fuel-cell-electric propulsion systems, etc.). Aspects of the present disclosure may also be equally applicable to aircraft engines which are not part of a propulsion system, for example, an engine for an auxiliary power unit (APU).

The gas turbine engine 22 of FIG. 2 includes a compressor section 26, a combustor section 28, a turbine section 30, an engine static structure 32, and an engine oil system 34. The combustor section 28 includes a combustor 36 (e.g., an annular combustor). The turbine section 30 of FIG. 2 includes a high-pressure turbine (HPT) section 30A and a low-pressure turbine (LPT) section 30B.

Components of the compressor section 26 and/or the turbine section 30 form a first rotational assembly 38 (e.g., a high-pressure spool) and a second rotational assembly 40 of the gas turbine engine 22. The first rotational assembly 38 and the second rotational assembly 40 are mounted for rotation about a rotational axis 42 (e.g., an axial centerline) of the gas turbine engine 22 relative to the engine static structure 32.

The first rotational assembly 38 includes a first shaft 44, a bladed compressor rotor 46 for the compressor section 26, and a bladed first turbine rotor 48 for the high-pressure turbine section 30A. The first shaft 44 interconnects the bladed first compressor rotor 46 and the bladed first turbine rotor 48.

The second rotational assembly 40 includes a second shaft 50 (e.g., an engine output shaft) and a bladed second turbine rotor 52 (e.g., a power turbine rotor) for the low-pressure turbine section 30B. The second shaft 50 is connected to the bladed second turbine rotor 52. The second shaft 50 couples the bladed second turbine rotor 52 with a propulsor 54 (e.g., a propeller) of the propulsion system 20. The second shaft 50 of FIG. 2 is coupled to the propulsor 54 by a gear train 56. For example, the gear train 56 of FIG. 2 includes a reduction gear box (RGB) 58 including a gear assembly (e.g., an epicyclic gear assembly) configured to drive the propulsor 54 at a reduced rotational speed relative to the second shaft 50. Alternatively, the second shaft 50 may be directed coupled to the propulsor 54 to drive the propulsor 54 at a same rotational speed as the second shaft 50.

The engine static structure 32 includes one or more engine cases, cowlings, inner fixed structures, and/or other non-rotating structures configured to house and/or support components of the gas turbine engine sections 26, 28, 30. The engine static structure 32 further includes one or more bearing assemblies configured to rotationally support components of the first rotational assembly 38 and the second rotational assembly 40.

In operation of the gas turbine engine 22, ambient air is directed into (e.g., from an air intake) and through the compressor section 26 along a core flow path 60. Air flow along the core flow path 60 is compressed in the compressor section 26, mixed and burned with fuel in the combustor 36, and the resultant combustion gas is directed through the high-pressure turbine section 30A and the low-pressure turbine section 30B. The bladed first turbine rotor 48 and the bladed second turbine rotor 52 rotationally drive the first rotational assembly 38 and the second rotational assembly 40, respectively, in response to the combustion gas flow through the high-pressure turbine section 30A and the low-pressure turbine section 30B. The second rotational assembly 40 drives rotation of the propulsor 54 to generate thrust for the propulsion system 20.

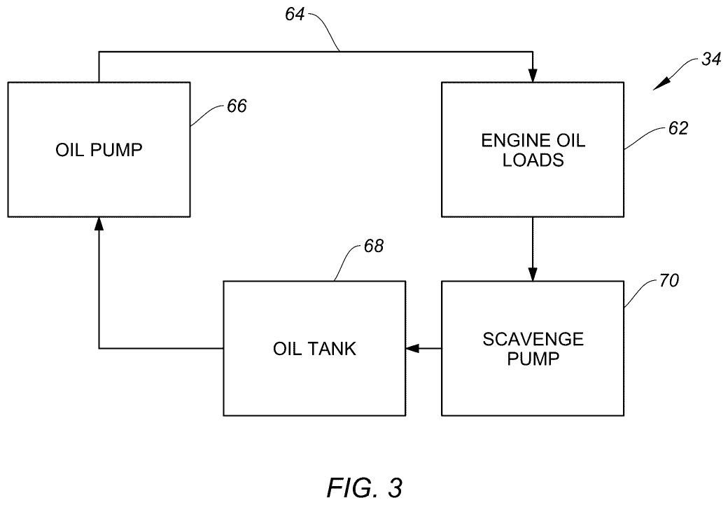

Referring to FIG. 3, the engine oil system 34 is configured to facilitate lubrication and/or cooling for components of the propulsion system 20 and its gas turbine engine 22. FIG. 3 schematically illustrates the engine oil system 34. The present disclosure is not limited to the foregoing exemplary configuration of the engine oil system 34 of FIG. 3, and the engine oil system 34 may include additional and/or alternative oil system components (e.g., tanks, valves, heat exchangers, pumps, conduits, regulators, etc.) suitable for facilitating lubrication and/or cooling for components of the propulsion system 20 and its gas turbine engine 22, referred to herein as engine oil loads 62. The engine oil loads 62 may include, but are not limited to, bearing assemblies, gear train 56 components (e.g., the reduction gear box 58), shafts (e.g., the first shaft 44 and the second shaft 50), and the like.

The engine oil system 34 includes an oil flow path 64, an oil pump 66, an oil tank 68, and a scavenge pump assembly 70. The oil pump 66 is configured to circulate oil from the oil tank 68 along the oil flow path 64 to direct (e.g., pump) the oil to the engine oil loads 62 for lubrication and/or cooling of the engine oil loads 62. Oil from the engine oil loads 62 is directed to return to the oil tank 68 by the scavenge pump assembly 70. For example, the scavenge pump assembly 70 may operate to direct (e.g., pump) oil from one or more of the engine oil loads 62, or an oil sump downstream of the engine oil loads 62, to the oil tank 68.

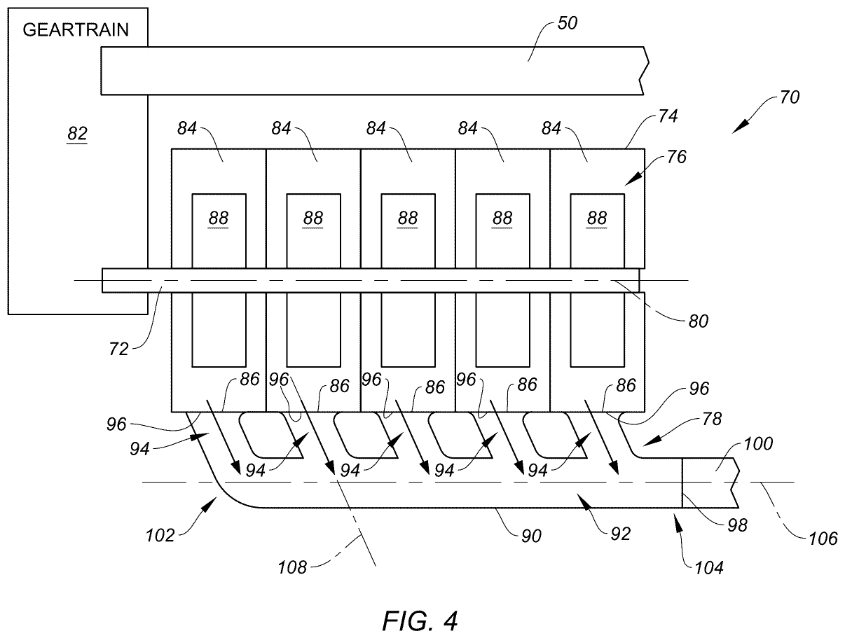

FIG. 4 schematically illustrates a cutaway, side view of the scavenge pump assembly 70. The scavenge pump assembly 70 includes a drive shaft 72, a pump housing 74, a plurality of scavenge pumps 76, and a scavenge return manifold 78. The drive shaft 72 is rotatable about an axis 80 (e.g., a rotational axis). The drive shaft 72 is coupled with an engine shaft of the gas turbine engine 22, such as the second shaft 50, as shown in FIG. 4. The drive shaft 72 of FIG. 4 is coupled with the second shaft 50 by a gear train 82. The gear train 82 may be part of the gear train 56. Alternatively, the gear train 82 may be a discrete gear train coupled with the second shaft 50 (or another engine shaft) independent of the gear train 56. The drive shaft 72 of FIG. 4 is configured to be rotationally driven about the axis 80 by the second shaft 50 through the gear train 82.

The pump housing 74 extends along the axis 80 about the drive shaft 72. The pump housing 74 may facilitate rotational support of the drive shaft 72. The pump housing 74 houses each of the scavenge pumps 76. For example, the pump housing 74 may form a pump cavity 84 for each of the scavenge pumps 76. The pump cavity 84 of each of the scavenge pumps 76 is connected in fluid communication with the engine oil loads 62 (e.g., one engine oil load 62, a portion of one of the engine oil loads 62, etc.) along the oil flow path 64. The pump housing 74 forms a pump outlet 86 for each of the respective scavenge pumps 76 and pump cavities 84. Each of the pump outlets 86 is disposed at (e.g., on, adjacent, or proximate) and connected in fluid communication with the scavenge return manifold 78.

Each of the scavenge pumps 76 is driven by rotation of the drive shaft 72. For example, each of the scavenge pumps 76 includes a pump rotor 88 mounted on or otherwise coupled with the drive shaft 72 within a respective one of the pump cavities 84.

The scavenge return manifold 78 includes a manifold body 90. The manifold body 90 forms a common outlet passage 92 and a plurality of inlet passages 94 of the scavenge return manifold 78. Each of the inlet passages 94 includes a manifold inlet 96 of the scavenge return manifold 78 disposed at (e.g., on, adjacent, or proximate) and connected in fluid communication with a respective one of the pump outlets 86. The common outlet passage 92 includes a manifold outlet 98 of the scavenge return manifold 78. The manifold outlet 98 is connected in fluid communication with the oil tank 68. For example, the manifold outlet 98 may be connected to a conduit 100 (e.g., a pipe) forming all or a portion of the oil flow path 64 between the scavenge return manifold 78 and the oil tank 68.

The common outlet passage 92 extends between and to an upstream end 102 of the common outlet passage 92 and a downstream end 104 of the common outlet passage 92. The downstream end 104 is disposed on the manifold outlet 98. The common outlet passage 92 extends along an outlet axis 106 for all or at least a substantial portion of the common outlet passage 92 from the upstream end 102 to the downstream end 104.

Each of the inlet passages 94 extends between and to its manifold inlet 96 and the common outlet passage 92. Each of the inlet passages 94 extends along an inlet axis 108 (e.g., a centerline axis) from its manifold inlet 96 to the common outlet passage 92. The inlet passages 94 are arranged sequentially along the manifold body 90 in an axial direction relative to the outlet axis 106. For example, the inlet passages 94 of FIG. 4 are arranged axially along the manifold body 90 from the upstream end 102 toward the downstream end 104. As can be seen in FIG. 4, the inlet passages 94 may be understood to be disposed on a plane on which the outlet axis 106 lies; however, the present disclosure is not limited to this particular orientation of the inlet passages 94 relative to the common outlet passage 92 and its outlet axis 106.

Each of the inlet passages 94 is arranged non-orthogonally relative to the common outlet passage 92. For example, the inlet axis 108 of each of the respective inlet passages 94 may be oriented non-orthogonal to an axial direction (e.g., an upstream-to-downstream direction) of the common outlet passage 92 (e.g., along the outlet axis 106). Each of the inlet passages 94 extends in an oblique direction from its manifold inlet 96 to the common outlet passage 92. The term “oblique direction,” as used herein, includes an upstream-to-downstream directional component, relative to the common outlet passage 92 (e.g., the outlet axis 106), from the manifold inlet 96 to the common outlet passage 92. The inlet passages 94 (e.g., the inlet axis 108) may each be oriented in a same or substantially same oblique direction (e.g., +/−20 degrees); however, the present disclosure is not limited to the inlet passages 94 being oriented in a same or substantially same oblique direction.

During operation of the gas turbine engine 22 and its engine oil system 34, rotation of the drive shaft 72 drives the scavenge pumps 76 (e.g., the pump rotors 88) to direct (e.g., pump) oil from the engine oil loads 62 back to the oil tank 68 through the scavenge return manifold 78. Each of the scavenge pumps 76, sequentially arranged along the manifold body 90 in an axial direction relative to the outlet axis 106, pump oil into the scavenge return manifold 78 through the respective inlet passages 94. The orientation of each of the inlet passages 94 in the oblique direction facilitate improved oil flow merging and flow efficiency within the common outlet passage 92. Accordingly, a size of the scavenge return manifold 78 may be reduced (e.g., relative to at least some conventional scavenge return manifolds) while still facilitating a sufficient oil flow rate from the scavenge pumps 76 to the oil tank 68 along the oil flow path 64. As a result, the present disclosure facilitates a reduced spatial footprint as well as a weight of the scavenge return manifold 78.

While the principles of the disclosure have been described above in connection with specific apparatuses and methods, it is to be clearly understood that this description is made only by way of example and not as limitation on the scope of the disclosure. Specific details are given in the above description to provide a thorough understanding of the embodiments. However, it is understood that the embodiments may be practiced without these specific details.

It is noted that the embodiments may be described as a process which is depicted as a flowchart, a flow diagram, a block diagram, etc. Although any one of these structures may describe the operations as a sequential process, many of the operations can be performed in parallel or concurrently. In addition, the order of the operations may be rearranged. A process may correspond to a method, a function, a procedure, a subroutine, a subprogram, etc.

The singular forms “a,” “an,” and “the” refer to one or more than one, unless the context clearly dictates otherwise. For example, the term “comprising a specimen” includes single or plural specimens and is considered equivalent to the phrase “comprising at least one specimen.” The term “or” refers to a single element of stated alternative elements or a combination of two or more elements unless the context clearly indicates otherwise. As used herein, “comprises” means “includes.” Thus, “comprising A or B,” means “including A or B, or A and B,” without excluding additional elements.

It is noted that various connections are set forth between elements in the present description and drawings (the contents of which are included in this disclosure by way of reference). It is noted that these connections are general and, unless specified otherwise, may be direct or indirect and that this specification is not intended to be limiting in this respect. Any reference to attached, fixed, connected, or the like may include permanent, removable, temporary, partial, full and/or any other possible attachment option.

The terms “substantially,” “about,” “approximately,” and other similar terms of approximation used throughout this patent application are intended to encompass variations or ranges that are reasonable and customary in the relevant field. These terms should be construed as allowing for variations that do not alter the basic essence or functionality of the invention. Such variations may include, but are not limited to, variations due to manufacturing tolerances, materials used, or inherent characteristics of the elements described in the claims and should be understood as falling within the scope of the claims unless explicitly stated otherwise.

No element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprise”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

While various inventive aspects, concepts and features of the disclosures may be described and illustrated herein as embodied in combination in the exemplary embodiments, these various aspects, concepts, and features may be used in many alternative embodiments, either individually or in various combinations and sub-combinations thereof. Unless expressly excluded herein all such combinations and sub-combinations are intended to be within the scope of the present application. Still further, while various alternative embodiments as to the various aspects, concepts, and features of the disclosures—such as alternative materials, structures, configurations, methods, devices, and components, and so on—may be described herein, such descriptions are not intended to be a complete or exhaustive list of available alternative embodiments, whether presently known or later developed. Those skilled in the art may readily adopt one or more of the inventive aspects, concepts, or features into additional embodiments and uses within the scope of the present application even if such embodiments are not expressly disclosed herein. For example, in the exemplary embodiments described above within the Detailed Description portion of the present specification, elements may be described as individual units and shown as independent of one another to facilitate the description. In alternative embodiments, such elements may be configured as combined elements.

1. An engine oil system for an aircraft engine, the engine oil system comprising:
an oil tank; and
a scavenge pump assembly including a drive shaft, a plurality of scavenge pumps, and a scavenge return manifold, each of the plurality of scavenge pumps including a pump rotor coupled with the drive shaft, the scavenge return manifold including a manifold body forming a common outlet passage and a plurality of inlet passages of the scavenge return manifold, the common outlet passage including a manifold outlet of the scavenge return manifold connected in fluid communication with the oil tank, each of the plurality of inlet passages including a manifold inlet of the scavenge return manifold connected in fluid communication with a respective one of the plurality of scavenge pumps, each of the plurality of inlet passages extending in an oblique direction from the manifold inlet to the common outlet passage.

2. The engine oil system of claim 1, wherein the common outlet passage extends along an outlet axis between and to an upstream end and a downstream end, the downstream end at the manifold outlet, and the plurality of inlet passages are arranged axially sequentially along the common outlet passage.

3. The engine oil system of claim 2, wherein each of the plurality of inlet passages is disposed on a plane on which the outlet axis lies.

4. The engine oil system of claim 1, wherein the oblique direction is substantially the same for each of the plurality of inlet passages.

5. The engine oil system of claim 1, wherein the scavenge pump assembly further includes a pump housing, the pump housing forms a plurality of pump cavities for the plurality of scavenge pumps, and each of the plurality of inlet passages is connected in fluid communication with a respective one of the plurality of pump cavities.

6. The engine oil system of claim 1, further comprising a plurality of engine oil loads, and the plurality of scavenge pumps are connected in fluid communication with the plurality of engine oil loads to pump oil from the plurality of engine oil loads into the scavenge return manifold.

7. An engine for an aircraft propulsion system, the engine comprising:
an engine oil system including a plurality of engine oil loads, an oil tank, and a scavenge pump assembly forming an oil flow path through the engine oil system, the scavenge pump assembly including a drive shaft, a plurality of scavenge pumps, and a scavenge return manifold,
each of the plurality of scavenge pumps operably connected to the drive shaft and configured to pump oil along the oil flow path from the plurality of engine oil loads to the scavenge return manifold, and
the scavenge return manifold including a manifold body forming a common outlet passage and a plurality of inlet passages of the scavenge return manifold, the common outlet passage including a manifold outlet of the scavenge return manifold connected in fluid communication with the oil tank, each of the plurality of inlet passages including a manifold inlet of the scavenge return manifold connected in fluid communication with a respective one of the plurality of scavenge pumps, each of the plurality of inlet passages extending non-orthogonally relative to the common outlet passage.

8. The engine of claim 7, further comprising an engine output shaft operably coupled to the drive shaft to drive rotation of the drive shaft.

9. The engine of claim 7, wherein the common outlet passage extends along an outlet axis between and to an upstream end and a downstream end, the downstream end at the manifold outlet, and the plurality of inlet passages are arranged axially sequentially along the common outlet passage.

10. The engine of claim 9, wherein each of the plurality of inlet passages is disposed on a plane on which the outlet axis lies.

11. The engine of claim 9, wherein each of the plurality of inlet passages extends along an inlet axis from the manifold inlet to the common outlet passage, and the inlet axis is non-orthogonal relative to an axial direction of the common outlet passage relative to the outlet axis.

12. The engine of claim 7, wherein each of the plurality of inlet passages extends in an oblique direction from the manifold inlet to the common outlet passage.

13. The engine of claim 12, wherein the oblique direction is substantially the same for each of the plurality of inlet passages.

14. The engine of claim 7, wherein the scavenge pump assembly further includes a pump housing, the pump housing forms a plurality of pump cavities for the plurality of scavenge pumps, and each of the plurality of inlet passages is connected in fluid communication with a respective one of the plurality of pump cavities.

15. A method for scavenging oil with an engine oil system of an aircraft engine, the method comprising:
supplying oil to a plurality of engine oil loads of the aircraft engine;
scavenging the oil from the plurality of engine loads with a plurality of scavenge pumps by pumping the oil into a scavenge return manifold, with each of the plurality of scavenge pumps, at an oblique direction relative to a common outlet passage of the scavenge return manifold; and
directing the oil from each of the plurality of scavenge pumps to an oil tank through the common outlet passage.

16. The method of claim 15, further comprising driving each of the plurality of scavenge pumps with a drive shaft operably connected to a pump rotor of each of the plurality of scavenge pumps.

17. The method of claim 15, wherein pumping the oil into the scavenge return manifold with each of the plurality of scavenge pumps includes pumping the oil through a plurality of inlet passages, each of the plurality of inlet passages connected in fluid communication between a respective one of the plurality of scavenge pumps and the common outlet passage.

18. The method of claim 17, wherein the common outlet passage extends along an outlet axis between and to an upstream end and a downstream end, and the plurality of inlet passages are arranged axially sequentially along the common outlet passage.

19. The method of claim 18, wherein the oblique direction is substantially the same for each of the plurality of inlet passages.

20. The method of claim 18, wherein each of the plurality of inlet passages is disposed on a plane on which the outlet axis lies.
